(19) United States
(12) Patent Application Publication
(10) Pub. No.: US 2014/0050541 A1
(43) Pub. Date: Feb. 20, 2014

(54) END MILL

(71) Applicant: OSG CORPORATION, Toyokawa-City (JP)

(72) Inventors: Hiroto Sugano, Toyokawa-shi (JP); Seiji Ohhashi, Toyokawa-shi (JP)

(73) Assignee: OSG CORPORATION, Toyokawa-City (JP)

(21) Appl. No.: 13/966,721

(22) Filed: Aug. 14, 2013

Related U.S. Application Data
(63) Continuation of application No. 11/918,561, filed on Jan. 14, 2008, now abandoned.

(51) Int. Cl. B23C 5/28; B23C 5/10

(52) U.S. Cl. CPC B23C 5/28; B23C 5/10
USPC 407/54

(57) ABSTRACT

Providing an end mill for reducing the use of the cutting fluid to prevent the environmental pollution.

Because the end mill 1 includes the openings 5a which open along spiral grooves 4, and the openings 5a communicate with the aperture on the rear end surface of the shank 2 via the intake path 5, the chips generated in the cutting are aspirated forcibly from the openings 5a when air intake is performed via the intake path 5, and the aspirated chips can be discharged from the aperture on the rear end surface of the shank 2. As a result, because the use of cutting fluid for discharging the chips can be reduced (or unnecessary) in comparison with conventional products, environmental pollution can be prevented.

### CROSS-REFERENCE TO RELATED APPLICATION

This application is a Continuation of copending application Ser. No. 11/918,561, filed on Jan. 14, 2008. Application Ser. No. 11/918,561 based upon a PCT International Application No. PCT/JP2006/324032 filed on Nov. 30, 2006. The entire contents of each of the above documents is hereby incorporated by reference into the present application.

### TECHNICAL FIELD

The present invention relates to end mills, particularly, to an end mill for preventing environmental pollution.

### BACKGROUND ART

Generally, in a cutting process with use of an end mill, supply of cutting fluid for discharge of chips are important for expanding tool life and securing machining precision.

As a method for supplying the cutting fluid, an external oil supply method for supplying the cutting fluid from the external to cutting blades is popular. In this method, the cutting fluid splashes by centrifugal force in high speed rotation, and thus is not sufficiently supplied to the blade edges. Conventionally, various techniques about a method superior to the external oil supply method in effective oil supply, namely, an internal oil supply method for supplying the cutting fluid from an oil hole penetrating inside of an end mill, have been proposed, for example, in Japanese Patent Application Laid-Open Publication Nos. H5-253727, H6-31321, H6-335815, and 2003-285220.

### DISCLOSURE OF THE INVENTION

### Problems to be Solved by the Invention

However, generally, because the cutting fluid includes a toxic substance such as chlorine and phosphorus, the cutting fluid disadvantageously causes environmental pollution when the cutting fluid is used. As a result, because the cutting fluid needs to be recovered completely, and thus its cost becomes high, development of techniques for reducing use of the cutting fluid has been desired in recent years.

The present invention is made for solving the above problems, and has an object to provide an end mill for reducing or eliminating the use of the cutting fluid to prevent the environmental pollution.

### Means for Solving the Problem

For achieving the object, the first aspect of the present invention is an end mill having: a shank; a body provided next to the shank; a spiral groove recessed on an outer periphery of the body and spiraling about a center axis; a peripheral cutting blade formed along the spiral groove; and an end cutting blade provided next to the peripheral cutting blade and formed on a bottom portion of the body, the end mill comprising: an intake path extending from a rear end surface of the shank to the body linearly along the center axis, and having a circular cross section. A diameter of the intake path is smaller than a blade diameter of the peripheral cutting blade and larger than a core diameter of the spiral groove, the intake path having an opening which opens along the spiral groove. A chip generated in cutting is aspirated from the opening and discharged from an aperture of the rear end surface of the shank by performing air intake via the intake path.

According to the second aspect, in the end mill of the first aspect,the diameter of the intake path is equal to or less than 65 percent of the blade diameter of the peripheral cutting blade.

According to the third aspect, in the end mill defined in the second aspect, the diameter of the intake path is 110-135 percent of the core diameter of the spiral groove.

According to the fourth aspect, in the end mill any one of the first to third aspects, an extending top of the intake path is separate from the bottom portion of the body; and a distance between the extending top of the intake path and the bottom portion of the body is 50-85 percent of the blade diameter of the peripheral cutting blade.

### Effects of the Invention

In an end mill according to the first aspect, because openings which open along spiral grooves are provided, and the openings communicate with an aperture on a rear end surface of a shank via an intake path, chips generated in cutting are aspirated forcibly from the openings when air intake is performed via the intake path, and the aspirated chips can be advantageously discharged from the aperture on the rear end surface of the shank.

As a result, because the use of cutting fluid for discharging the chips can be reduced (or unnecessary) in comparison with conventional products, environmental pollution can be advantageously prevented. Further, when the use of the cutting fluid for discharging the chips can be reduced (or unnecessary), cost of recovering the cutting fluid can be advantageously reduced, and thus cost of cutting can be advantageously reduced.

Additionally, because the chips aspirated from the openings can be discharged via the intake path and through the aperture on the rear end surface of the shank to the outside, cleaning can be advantageously simplified without scattering the chips on a workpiece, and the decrease of cutting precision caused by the chips scattered on the workpiece can be advantageously avoided.

Further, in the present invention, because the openings are established along the spiral grooves, and the chips are aspirated from the openings, the chip containing capability of the spiral grooves can be set low. In other words, even when a capacity (namely, such as a width and depth of the spiral grooves) of the spiral grooves is made small, the occurrence of the chip clogging can be minimized. Accordingly, the tool cross section can be increased by the reduction of the capacity of the spiral grooves. As a result, the rigidity of the body is increased, and thus the tool life can be advantageously increased.

Additionally, in the present invention, because one end of the intake path opens on the rear end surface, the constitution of a holder for discharging the chips can be advantageously simplified, for example, in comparison with the case of opening on a side surface of the shank.

In the end mill according to the second aspect, in addition to the advantage of the end mill of the first aspect, because the diameter of the intake path is equal to or less than 65 percent of the blade diameter of the peripheral cutting blades, the rigidity of the body can be advantageously secured.

This is because, when the diameter of the intake path is more than 65 percent of the blade diameter of the peripheral cutting blades, the wall thickness of the body becomes insufficient, thereby decreasing its body rigidity. In contrast, in the present invention, because the diameter of the intake path is equal to or less than 65 percent of the blade diameter of the peripheral cutting blades, the wall thickness of the body can be secured, and its rigidity can be secured. As a result, the tool rigidity can be improved.

In the end mill according to the third aspect, in addition to the end mill of the second aspect, because the diameter of the intake path is 110-135 percent of the core diameter of the spiral grooves, both the securing of the aspiration capability and the improvement of the tool life can be advantageously achieved.

This is because, when the diameter of the intake path is smaller than 110 percent of the core diameter of the spiral grooves, a width of each of the openings which open along the spiral grooves becomes small, the chips contained in the spiral grooves (for example, chips separate from the openings and relatively large chips) cannot be aspirated sufficiently, thereby decreasing the aspiration capability. In the present invention, because the diameter of the intake path is set to be within the above noted range relative to the core diameter, the opening width of each of the openings can be secured sufficiently. As a result, the chips contained in the spiral grooves can be aspirated more certainly.

On the other hand, because, when the diameter of the intake path is larger than 135 percent of the core diameter of the spiral grooves, the width of each of the openings which open along the spiral grooves becomes large, the aspiration capability is improved, but the rigidity of the body is decreased by the large openings. In the present invention, because the diameter of the intake path is set to be within the above noted range relative to the core diameter, the preferable width of each of the openings is ensured. Accordingly, the rigidity can be secured. As a result, the tool life can be improved while securing the aspiration capability.

In the end mill according to fourth aspect, an addition to the advantage of the end mill according to any one of the first to third aspects, because the extending top of the intake path is positioned separately from the bottom portion of the body, and a distance between the extending top of the intake path and the bottom of the body is 50-85 percent of the blade diameter of the peripheral cutting blades, the aspiration capability can be advantageously secured, and the tool life can be advantageously increased.

This is because, when the above distance is smaller than 50 percent of the blade diameter of the peripheral cutting blades, the distance between the extending top of the intake path and the bottom portion of the body becomes too small, so that the wall thickness of the bottom portion becomes insufficient. Accordingly, the rigidity of the body (bottom portion) is decreased, and the tool life is decreased. In the present invention, because the distance is within the above noted range relative to the blade diameter of the peripheral cutting blades, the above distance is secured sufficiently, and the wall of the bottom portion of the body can be made thick enough. As a result, the rigidity of the bottom portion is secured, and the tool life can be increased.

On the other hand, when the above distance is longer than 85 percent of the blade diameter of the peripheral cutting blades, the rigidity can be secured by thickening the wall of the bottom portion, but the ends of the openings are separated from the end cutting blades. Accordingly, the chips generated in the cutting by the bottom blades (and the peripheral cutting blades near the end cutting blades) cannot be aspirated sufficiently, decreasing the aspiration capability. In the present invention, because the above distance is within the above noted range relative to the blade diameter of the peripheral cutting blades, the ends of the openings can be prevented from being too separated from the end cutting blades. Accordingly, the aspiration capability can be improved while securing the tool life.

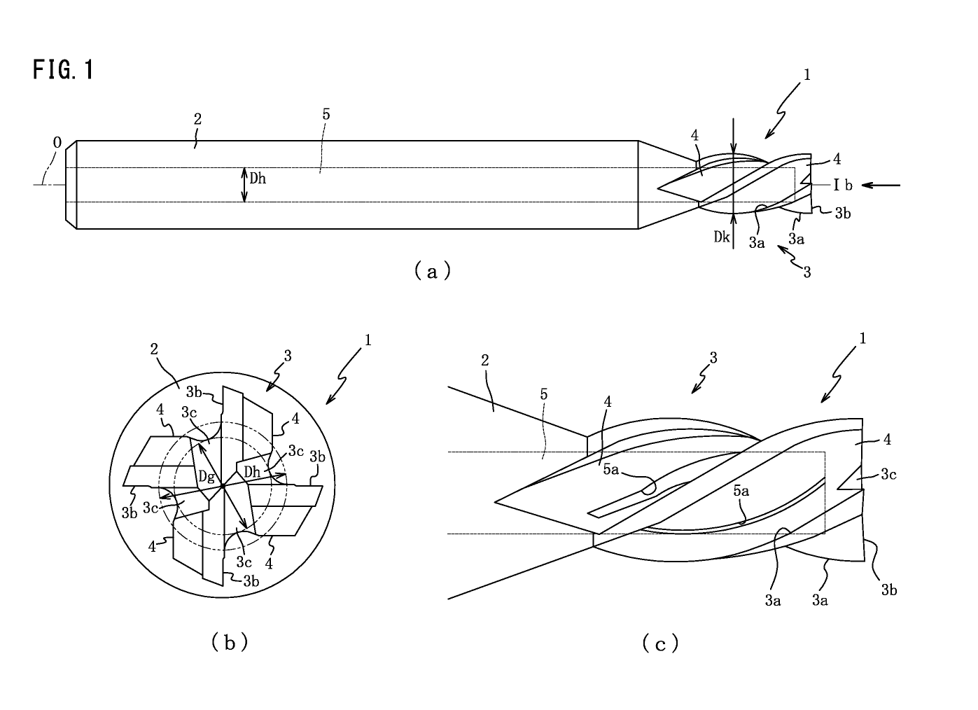

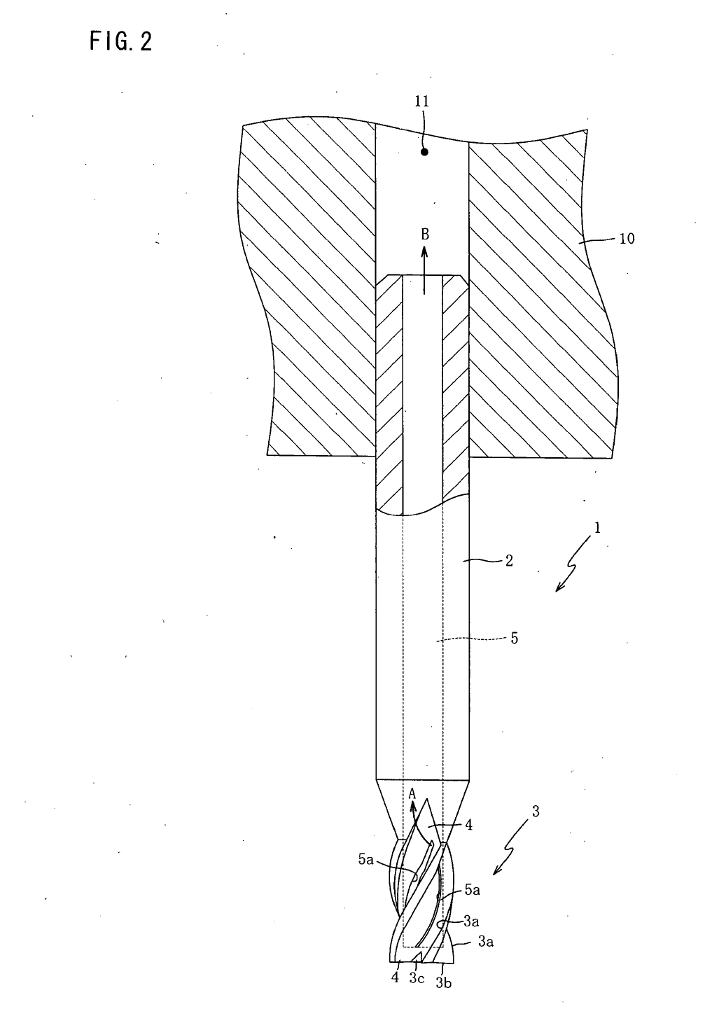

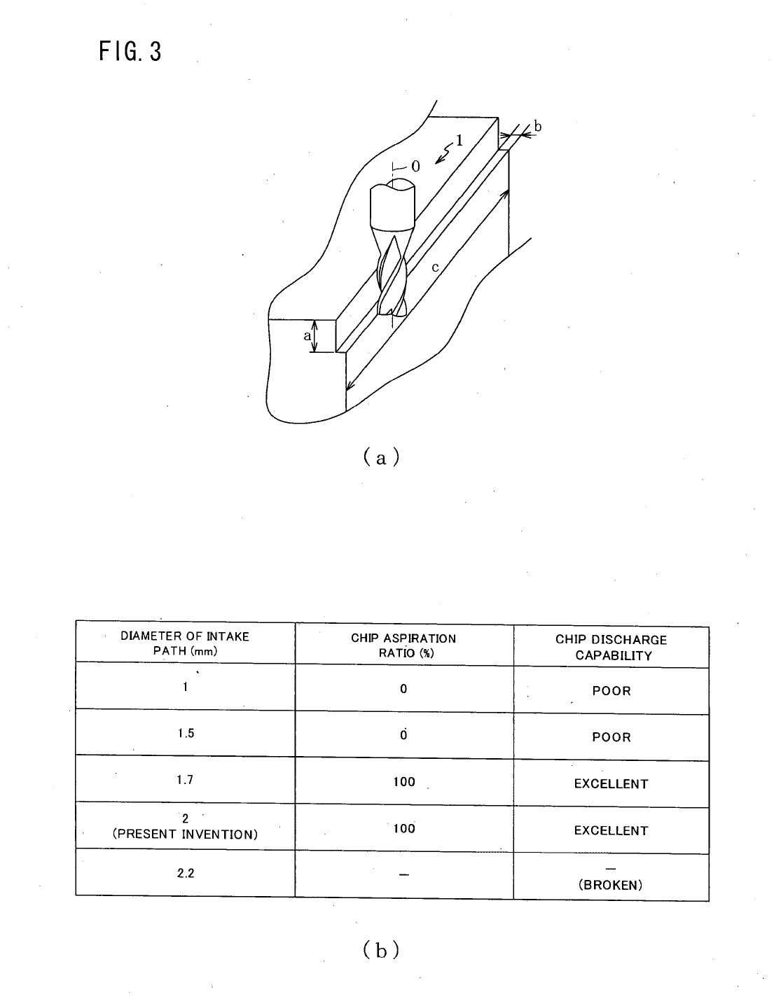

### BRIEF DESCRIPTION OF THE DRAWINGS

[FIG. 1] FIG. 1(a) is a front view of an end mill in one embodiment of the present invention, FIG. 1(b) is a side view of the end mill viewed from the direction of an arrow Ib of FIG. 1(a), and FIG. 1(c) is a partial enlarged view of the end mill in which the body 3 of FIG. 1(a) is enlarged.

[FIG. 2] is a front view of the end mill held by a holder.

[FIG. 3] FIG. 3(a) is an explanatory view showing a method for experiment in cutting, and FIG. 3(b) shows a result of the experiment in the cutting.

### EXPLANATION OF REFERENCE NUMERALS AND SYMBOLS

1 . . . end mill
2 . . . shank
3 . . . body
3a. . . peripheral cutting blade
3b. . . end cutting blade
4 . . . spiral groove
5 . . . intake path
5a. . . opening
Dg . . . core diameter of spiral groove
Dh . . . diameter of intake path
Dk . . . diameter of peripheral cutting blade
O . . . center axis

### BEST MODE FOR CARRYING OUT THE INVENTION

Preferred embodiments of the present invention are explained below in reference to the appended drawings. First, in reference to FIG. 1, an end mill 1 of one embodiment of the present invention is explained. FIG. 1(a) is a front view of the end mill 1, FIG. 1(b) is a side view of the end mill 1 viewed from the direction of an arrow Ib of FIG. 1(a), and FIG. 1(c) is a partial enlarged view of the end mill 1 where a body 3 is enlarged.

The end mill 1 is a tool for cutting a workpiece (not shown) by use of rotation force transmitted from a tooling machine (not shown). As shown in FIG. 1, the end mill 1 is a solid type square end mill constituted of cemented carbide, which is made by pressing and sintering, e.g., tungsten carbide (WC), and includes a shank 2 and the body 3 provided next to the shank 2. The end mill 1 may be constituted of high-speed tool steel, as well as cemented carbide.

The shank 2 is a portion held by the tooling machine via a holder 10 (see FIG. 2), and as shown in FIG. 1, formed as a cylindrical shape having a center axis O. As shown in FIG. 1(a), the shank 2 is tapered such that the external diameter becomes smaller toward a top side (the right side of FIG. 1(a)) of the shank 2.

The body 3 is a portion rotating during the cutting by the rotation force transmitted from the tooling machine via the shank 2. As shown in FIG. 1, the body 3 has a diameter smaller than the diameter of the shank 2, and mainly includes peripheral cutting blades 3a and end cutting blades 3b. Four spiral grooves 4 are recessed spirally on the periphery of the body 3.

Peripheral cutting blades 3a are portions for cutting a workpiece, and as shown in FIG. 1(a) and FIG. 1(c), the four peripheral cutting blades 3a are formed on the periphery of the body 3 along the after-mentioned spiral grooves 4. In this embodiment, a blade diameter Dk, the diameter of the peripheral cutting blades 3a, is 3 mm.

As well as the peripheral cutting blades, the end cutting blades 3b are portions for cutting the workpiece. As shown in FIG. 1, the four end cutting blades 3b are respectively provided next to the four peripheral cutting blades 3a, and formed on the bottom portion (the right side of FIG. 1(a)) of the body 3. Additionally, gashes 3c are provided to the end cutting blades 3b, thereby forming cutting faces of the end cutting blades 3b.

The spiral grooves 4 are portions for forming the cutting faces of the peripheral cutting blades 3a and for containing chips generated at the peripheral cutting blades 3a in cutting, and as shown in FIG. 1, extend from the bottom portion of the body 3 to a rear side (the left side of FIG. 1(a)) of the body 3. In this embodiment, a spiral angle of the spiral grooves 4 is set to thirty degrees.

The spiral grooves 4 are formed by rotating a disk-shaped grindstone and moving the grindstone from the bottom portion of the body 3 to the rear side of the body 3 parallel to the direction of the center axis O of the shank 2. Accordingly, a shape of a bottom groove of each of the spiral grooves 4 is substantially parallel to the center axis O on the bottom side (the right side of FIG. 1(a)) of the body 3, and ascends corresponding to a shape of the grindstone, so that a core diameter of the spiral grooves 4 becomes larger toward the rear side of the body 3. In this embodiment, a core diameter Dg of the spiral grooves 4 formed substantially parallel to the center axis O of the shank 2 on the bottom side of the body 3 is 1.5 mm.

Additionally, as shown in FIG. 1(a) and FIG. 1(c), inside the end mill 1, an intake path 5 extends straight from the rear end surface (the left side surface of FIG. 1(a)) of the shank 2 to a substantially center portion of the body 3 along the center axis O. Specifically, an extending top of the intake path 5 is separated from the bottom portion of the body 3 such that a distance between the extending top and the bottom portion of the body 3 is about 2 mm.

As described later, the intake path 5 is a portion where air intake is performed in cutting. The intake path 5 has a circular cross section which is created by applying electrical discharge machining to the shank 2 and the body 3, and has a diameter Dh smaller than the blade diameter Dk of the peripheral cutting blade 3a and larger than the core diameter Dg of the spiral grooves 4 as shown in FIG. 1(b). In this embodiment, the diameter Dh of the intake path 5 is 2 mm.

In this embodiment, as noted above, the intake path 5 is formed by electrical discharge machining. The intake path 5 may be formed by drilling. Like the end mill 1 in this embodiment, in an end mill having a small diameter such that the blade diameter of the peripheral cutting blades 3a is about 3 mm, the intake path 5 is preferably formed by electrical discharge machining. This is because when the intake path 5 of the end mill having the small diameter is formed by drilling, a drill shakes during the cutting process. Accordingly, a wall thickness of each of the peripheral cutting blades 3a becomes small which causes the decrease of their rigidity. Additionally, the cutting precision for the intake path 5 decreases, so that shapes of the openings 5a are unstable. In contrast, the intake path 5 is formed by electrical discharge machining, so that the rigidity of the peripheral cutting blades can be secured, and the shapes of the openings 5a are stable. As a result, the tool life can be increased, and the aspiration capability can be improved.

Additionally, the diameter Dh of the intake path 5 is smaller than the diameter Dk of the peripheral cutting blades 3a, and larger than the core diameter Dg of the spiral grooves 4, so that as shown in FIG. 1(c), the openings 5a are provided to the intake path 5.

The openings 5a are portions for aspirating the chips generated at the peripheral cutting blades 3a and end cutting blades 3b when air intake is performed via the intake path 5 in cutting, and as shown in FIG. 1(a) and FIG. 1(c), are open along the spiral grooves 4.

Next, a method for recovering chips by use of the end mill 1 constituted as described above is explained in reference to FIG. 2. FIG. 2 is a front view of the end mill 1 held by the holder 10. In FIG. 2, a cross section of part of the end mill 1 is shown, and part of the holder 10 is not shown. In FIG. 2, the moving direction of chips is schematically shown by arrows A and B.

As shown in FIG. 2, the shank 2 is held by the holder 10, so that the end mill 1 is mounted to a tooling machine (not shown). In cutting, air intake is performed for an internal space 11 formed in the holder 10 by a pump (not shown) from the tooling machine. Accordingly, in the end mill 1, air intake is performed via the intake path 5.

In this case, because the openings 5a are provided to the intake path 5 as described above, the chips generated at the peripheral cutting blades 3a and the end cutting blades 3b can be aspirated from the openings 5a forcibly as shown by the arrow A.

Additionally, the intake using the pump continues, so that the chips which have been aspirated from the openings 5a can be discharged from the rear side surface (the upper surface in FIG. 2) of the shank 2 to the outside via the intake path 5 as shown by the arrow B.

Next, an experiment on the cutting using the end mill 1 is explained in reference to FIG. 3. FIG. 3(a) is an explanatory view showing an experiment method on the cutting, and FIG. 3(b) shows the result of the experiment on the cutting.

In the experiment of the cutting, as shown in FIG. 3(a), when the end mill 1 is vertically opposed to a work surface Cf of a workpiece C, and the end mill 1 is moved in the direction transverse to the center axis O while rotating the end mill 1 about the center axis O under a predetermined condition, discharge capability for the chips generated in the cutting is examined. In this experiment of the cutting, a quality of the discharge capability is determined based on a chip aspiration ratio (ratio between generated chips and aspirated chips).

Detailed data are as follows. The workpiece is JIS-ADC12. The machine used is a vertical machining center. The spindle rate is 12,500/min. The feed rate is 900 mm/min. The cutting depth a (see FIG. 3(a)) is 3 mm. The cutting amount b (see FIG. 3(a)) is 0.3 mm. The cutting length c (see FIG. 3(a)) is 100 mm.

Additionally, in the experiment on the cutting, the end mill 1 (hereinafter called “the present invention”) having the diameter Dh of the intake path 5 is fixed to 2 mm, and other end mills the diameter Dh of which being variously changed in a predetermined range (from 1 mm to 2.2 mm), were used.

From the result of the experiment on the cutting, as shown in FIG. 3(b), when the present invention was used, the chip aspiration ratio was 100 percent. Accordingly, it can be understood that all the chips generated in the cutting were able to be aspirated. As a result, the chip discharge capability was excellent.

Similarly, when the diameter Dh of the intake path 5 was 1.7 mm, the chip aspiration ratio was 100 percent. It can be understood that all the chips generated in the cutting were able to be aspirated. As a result, the chip discharge capability was excellent.

Additionally, when the diameter Dh of the intake hole 5 was 1 mm and 1.5 mm, the chip aspiration ratio was zero percent. It can be understood that no chip generated in the cutting was able to be aspirated. As a result, each of the chip discharge capabilities was poor.

This can be considered to be caused by the fact that, because the diameter Dh of the intake hole 5 was smaller than or the same as the core diameter Dg (=1.5 mm) of the grooves 4, the openings 5a were unable to be formed on the intake hole 5, and thus the chips were unable to be aspirated.

On the other hand, when the diameter Dh of the intake path 5 was 2.2 mm, the end mill was broken. This can be considered to be caused by the fact that, because the diameter Dh of the intake path 5 was large relative to the blade diameter Dk (=3 mm) of the peripheral cutting blades 3a, a wall thickness of the body 3 was too much reduced, decreasing the tool rigidity.

From this result, the diameter Dh of the intake path 5 is preferably set equal to or less than 65 percent of the diameter Dk of the peripheral cutting blades 3a. This is because, when the diameter Dh of the intake path 5 is larger than 65 percent of the blade diameter Dk of the peripheral cutting blades 3a, the wall thickness of the body 3 is reduced too much, decreasing its rigidity. In contrast, when the diameter Dh of the intake path 5 is equal to or less than 65 percent of the blade diameter Dk of the peripheral cutting blades 3a to secure the wall thickness of the body 3, so that its rigidity can be secured. As a result, the tool life can be improved.

Further, the diameter Dh of the intake path 5 is preferably 110-135 percent of the core diameter Dg of the spiral grooves 4. This is because, when the diameter Dh of the intake path 5 is smaller than 110 percent of the core diameter Dg of the spiral grooves 4, a width of each of the openings 5a which open along the spiral grooves 4 becomes small, the chips contained in the spiral grooves 4 (for example, chips separate from the openings 5a and relatively large chips) cannot be aspirated sufficiently, thereby decreasing the aspiration capability. Since the diameter Dh of the intake path 5 is within the above noted range relative to the core diameter Dg of the spiral grooves 4, the opening width of each of the openings 5a can be secured sufficiently. As a result, the chips contained in the spiral grooves 4 can be aspirated more certainly.

In contrast, when the diameter Dh of the intake path 5 is larger than 135 percent of the core diameter Dg of the spiral grooves 4, the width of each of the openings 5a which open along the spiral grooves 4 becomes large, the aspiration capability is improved, but the rigidity of the body 3 is decreased by the enlarged openings. Since the diameter Dh of the intake path 5 is within the above noted range relative to the core diameter Dg of the spiral grooves 4, the width of each of the openings 5a is prevented from being too large. Accordingly, the rigidity of the body 3 can be secured. As a result, the tool life can be improved while securing the aspiration capability.

As described above, because the end mill 1 in this embodiment includes the openings 5a which open along spiral grooves 4, and the openings 5a communicate with the aperture on the rear end surface of the shank 2 via the intake path 5, the chips generated in the cutting are aspirated forcibly from the openings 5a when air intake is performed via the intake path 5, and the aspirated chips can be discharged from the aperture on the rear end surface of the shank 2.

As a result, because the use of cutting fluid for discharging the chips can be reduced (or eliminated) in comparison with conventional products, environmental pollution can be prevented. Further, when the use of the cutting fluid for discharging the chips can be reduced (or eliminated), cost for recovering the cutting fluid can be reduced, and thus overall cost for the cutting can be reduced as well.

Additionally, because the chips aspirated from the openings 5a can be discharged via the intake path 5 through the aperture on the rear end surface of the shank 2 to the outside, cleaning can be simplified without scattering the chips on a workpiece, and the decrease of cutting precision caused by the chips scattered on the workpiece can be avoided.

Further, in the end mill 1 in this embodiment, because the openings 5a are open along the spiral grooves 4, and the chips are aspirated from the openings 5a, the chip containing capability using the spiral grooves 4 can be set low. In other words, even when a capacity (namely, a width and depth of each the spiral grooves) of the spiral grooves 4 is made small, the occurrence of the chip clogging can be suppressed. Accordingly, the tool cross section can be increased by the reduction of the capacity of the spiral grooves 4. As a result, the rigidity of the body 3 is secured, and thus the tool life can be advantageously increased.

Additionally, in the end mill 1 in this embodiment, because one end of the intake path 5 opens on the rear end surface of the shank 2, the constitution of the holder 10 for discharging the chips can be simplified, for example, in comparison with the case of opening on a side surface of the shank 2.

In the foregoing, the case where the extending top of the intake path 5 in the end mill 1 in this embodiment is separated from the bottom portion of the body 3 such that a distance between the extending top and the bottom portion of the body 3 is almost 2 mm has been explained (see FIG. 1(a) and FIG. 1(c)). The distance between the extending top and the bottom portion of the body 3 is preferably 50-85 percent of the blade diameter Dk of the peripheral cutting blades 3a.

This is because, when the above distance is smaller than 50 percent of the blade diameter Dk of the peripheral cutting blades 3a, the distance between the extending top of the intake path 5 and the bottom portion of the body 3 becomes too small, so that the wall thickness of the bottom portion of the body 3 becomes insufficient. Accordingly, the rigidity of the body 3 (bottom portion) is decreased, and thus the tool life will be decreased. Since the distance is within the above noted range relative to the blade diameter Dk of the peripheral cutting blades 3a, the above distance is secured sufficiently, and the wall of the bottom portion of the body 3 can be made thick enough. As a result, the rigidity of the bottom portion is secured, and the tool life can be increased.

On the other hand, when the above distance is longer than 85 percent of the blade diameter Dk of the peripheral cutting blades 3a, the rigidity can be secured by thickening the wall of the bottom portion, but the ends of the openings 5a are separated from the end cutting blades 3b. Accordingly, the chips generated in the cutting by the end cutting blades 3b (and the peripheral cutting blades 3a near the end cutting blades 3b) cannot be aspirated sufficiently, thereby decreasing the aspiration capability. Since the above distance is within the above noted range relative to the blade diameter Dk of the peripheral cutting blades 3a, the ends of the openings 5a can be prevented from being too separated from the end cutting blades 3b. Accordingly, the aspiration capability can be improved while securing the tool life.

The present invention has been explained according to the embodiments, but the present invention is not limited to the above embodiments. It can be easily guessed that various changes may be made without departing from the scope of the invention.

For example, in the above embodiments, the case where the end mill 1 is constituted as a square end mill has been explained, but the end mill 1 is not limited to the square end mill. For example, the end mill 1 may be constituted as a radius end mill or a ball end mill.

In the above embodiments, the case where the four peripheral cutting blades 3a and the four spiral grooves 4 forming the cutting faces of the four peripheral cutting blades 3a are provided, has been explained, but the present invention is not limited to this case. For example, one, two or three of the spiral grooves 4 may be provided, or five or more of the spiral grooves 4 may be provided. The three or four spiral grooves 4 are preferably provided because the chip aspiration capability decreases when the one or two spiral grooves 4 are provided, and because the tool rigidity decreases when the five or more spiral grooves 4 are provided.

In the above embodiments, the case where the peripheral cutting blades 3a and the end cutting blades 3b are formed at the body 3, has been explained, but the present invention is not limited to this case. The peripheral cutting blades 3a and the end cutting blades 3b can be constituted detachably to the body 3 by use of throw away tips, so that the end mill 1 may be constituted as a throw away end mill. In this case, the tool life can be increased by exchanging the tips.

In the above embodiments, the case where the extending top of the intake path 5 is separated from the bottom portion of the body 3, has been explained, but the present invention is not limited to this case. The intake path 5 may extend through the body 3 to the bottom portion of the body 3. In this case, to prevent the problem where the aspiration force decreases because sufficient negative pressure cannot be obtained in the openings 5a in the intake, the blade diameter Dk of the peripheral cutting blades 3a is preferably set to 5 mm or less, particularly to 3 mm or less. Further, the blade diameter Dk is preferably set to 2 mm or less.

1. A square end mill comprising:
a shank;
a body provided next to the shank;
a spiral groove recessed on an outer periphery of the body and spiraling about a center axis;
a peripheral cutting blade formed along the spiral groove; and
an end cutting blade provided next to the peripheral cutting blade and formed on a bottom portion of the body; and
an intake path extending straight from a rear end surface of the shank to the body along the center axis, and having a circular cross section,
wherein a diameter of the intake path is smaller than a blade diameter of the peripheral cutting blade and larger than a core diameter of the spiral groove, the diameter of the intake path is the same form the rear end surface to an extending top, and the intake path having an opening which opens along the spiral groove; and
wherein a chip generated in cutting is aspirated from the opening and discharged from an aperture of the rear end surface of the shank by performing air intake via the intake path; and
wherein the extending top of the intake path is separated from the bottom portion of the body in such a way that a distance between the extending top ot the intake parh and the bottom portion of the body is 50-85 percent of the blade diameter of the peripheral cutting blade.

2. The square end mill according to claim 1,
wherein the diameter of the intake path is equal to or less than 65 percent of the blade diameter of the peripheral cutting blade.

3. The square end mill of claim 2,
wherein the diameter of the intake path is 110-135 percent of the core diameter of the spiral groove.

4. (canceled)
